(19) United States
(12) Patent Application Publication
(10) Pub. No.: US 2014/0279589 A1
(43) Pub. Date: Sep. 18, 2014

(54) SYSTEM, METHOD, AND COMPUTER READABLE MEDIUM FOR DISPLAY AND TRACKING OF LEGAL ACTIVITY

(71) Applicant: Ontario Systems, LLC, Muncie, IN (US)

(72) Inventors: Amy Kennedy, Midlothian, VA (US); Beth Waters, Muncie, IN (US); Dwayne Lott, Farmland, IN (US); Seth Corduan, Muncie, IN (US); Matt Holcomb, Anderson, IN (US); Jim Howell, Fishers, IN (US); Josh Sprague, Muncie, IN (US); Tyler Roark, Yorktown, IN (US)

(21) Appl. No.: 14/212,802

(22) Filed: Mar. 14, 2014

Related U.S. Application Data
(60) Provisional application No. 61/798,634, filed on Mar. 15, 2013.

(51) Int. Cl. G06Q 50/18; G06Q 10/10

(52) U.S. Cl. CPC G06Q 50/18; G06Q 10/10
USPC 705/311

(57) ABSTRACT

Various embodiments of systems, methods, and computer-readable programs for display and tracking of legal activity are disclosed. The disclosed systems, methods, and computer-readable programs disclosed herein enable an entity, entities, individual, or individuals (e.g., enterprises, legal teams, audit teams, collection departments and others) to track legal activities performed in various cases within various court systems and to identify procedural patterns for each tracked case. In addition, the systems, methods, and computer-readable programs disclosed herein facilitate the display of procedural information important to each court case in a way to enable an enterprise to identify what has been performed in each case, what needs to happen next, sample forms that can used to initiate the next step, and the actual and predicted costs associated therewith.

### RELATED APPLICATIONS

This application is related to, and claims the priority benefit of, U.S. Provisional Patent Application Ser. No. 61/798,634, filed Mar. 15, 2013, the contents of which are hereby incorporated by reference in their entirety into this disclosure.

### BACKGROUND

Every court is different and each jurisdiction may create local rules specific to that court system, follow procedural rules in different ways, and/or levy different costs for court filings and other legal activities performed by plaintiffs, and defendants within the court system. Adding further confusion, these courts may also change procedural requirements from time to time. As a result, a civil case in one jurisdiction may have a different procedural process than a civil case with similar facts in a different jurisdiction. Moreover, activities performed in each civil case require certain, and sometimes special, documents and the payment of various fees.

Today, enterprises that are engaged in multiple cases throughout multiple legal jurisdictions need to track various legal activities performed in each case and identify the recommended procedural process for each case based on jurisdictional requirements, the type of case involved, and other factors. In some instances, the enterprise will attempt to track and identify ongoing legal processes through the maintenance of a large spreadsheet with manual recordation of each event taken and input of the next step in the process as a case unfolds.

In the receivables management industry, attempts to collect unpaid debt may result in the need to file legal proceedings against debtors. Today, collectors in the receivables management industry have little insight into the procedural posture of legal proceedings performed to try to obtain payment on such unpaid debt. In addition, collection agencies generally perform the same types of legal activities again and again to recover unpaid debt, without any connection between cases to find efficiencies or establish common procedural tasks or templates to reduce errors.

To improve upon this manual process, some systems exist that attempt to track legal activities within courts on behalf of an enterprise (e.g., a collection agency). However, today, these systems suffer from the need to manually input all data for all courts into the system, each with their document and cost requirements for every legal activity possible in each court. As such, every legal activity starts from a blank slate with no real mechanism to determine suggested norms or costs related to such legal activities. Alternatively, some systems include manually created process flows describing the initial legal activity to be performed in a case, every legal activity to be performed thereafter, and how long to wait between each step of the legal process. Populating systems with this information requires the system owner to invest great effort before the system is useable, and the implementation process is prone to potential data entry errors. Moreover, such a process fails to appreciate any changes in standard legal processes, such as, for example, through creation of new local rules, changes in law, or general preference among enterprises using the system.

Due to the limitations of such systems and the variances among jurisdictions, enterprises using these systems suffer from the inability to quickly understand what legal activities have been performed in an individual case, costs associated with an individual case, and generally where the enterprise is in the legal process common to cases of that case type. This is especially relevant in the accounts receivable management industry, where collection agencies are faced with navigating the differing requirements of various jurisdictions when initiating and monitoring a collection action against a debtor.

Accordingly, there exists a need for a system, method, and computer-readable medium for display and tracking of legal activity that can create procedural patterns for individual court cases based on past behavior within the applicable court system for that type of court case. In addition, there exists a need for a system, method, and computer-readable medium to represent procedural activity within each court case in an efficient way.

### SUMMARY

Various embodiments of systems, methods, and computer-readable programs for display and tracking of legal activity are disclosed. The disclosed systems, methods, and computer-readable programs disclosed herein enable an entity, entities, individual, or individuals (e.g., enterprises, legal teams, audit teams, collection departments and others) to track legal activities performed in various cases within various court systems and to identify procedural patterns for each tracked case.

The present disclosure includes disclosure of at least one embodiment of a method for tracking and displaying legal activity, the method comprising the steps of establishing legal proceeding information in a computer database, the legal proceeding information including a type and a jurisdiction; generating, with the assistance of a computer, a suggested procedural sequence based at least in part on the type and the jurisdiction; and tracking, with the assistance of a computer, at least one legal activity. In at least one aspect of the present disclosure, a method according to at least one embodiment of the present disclosure comprises the step of suggesting form documents to be used to initiate at least one legal activity. In at least one aspect of the present disclosure, a method according to at least one embodiment of the present disclosure comprises the step of providing the costs associated with at least one legal activity. In at least one aspect of the present disclosure, a method according to at least one embodiment of the present disclosure comprises the step of providing reminders related to estimated time period for response actions to occur in view of at least one legal activity.

The present disclosure includes disclosure of at least one embodiment of a system for tracking and displaying legal activity, the system comprising a non-transitory computer-readable medium with a computer program for tracking and displaying legal activity stored thereon, the non-transitory computer-readable medium comprising code portions stored thereon, the computer-readable medium code portions comprising a first executable code portion for identifying a court for a legal proceeding, a second executable code portion for generating a suggested procedural sequence based at least in part on the identified court, and a third executable code portion for tracking at least one legal activity performed in the legal proceeding; and a processor for executing the code portions. In at least one aspect of the present disclosure, a system according to at least one embodiment of the present disclosure comprises an executable code portion for suggesting form documents to be used to initiate at least one legal activity. In at least one aspect of the present disclosure, a system according to at least one embodiment of the present disclosure comprises an executable code portion for providing the costs associated with at least one legal activity. In at least one aspect of the present disclosure, a system according to at least one embodiment of the present disclosure comprises an executable code portion for providing a reminder related to an estimated time period for response actions to occur in view of at least one legal activity.

The present disclosure includes disclosure of at least one embodiment of a non-transitory computer-readable medium with a computer program for tracking and displaying legal activity stored thereon, the non-transitory computer-readable medium comprising code portions stored thereon, the computer-readable medium code portions comprising a first executable code portion for identifying a court for a legal proceeding; a second executable code portion for generating a suggested procedural sequence based at least in part on the identified court; and a third executable code portion for tracking at least one legal activity performed in the legal proceeding.

### BRIEF DESCRIPTION OF THE DRAWINGS

The features and advantages of this disclosure, and the manner of attaining them, will be more apparent and better understood by reference to the following descriptions of the disclosed method and computer-readable program, taken in conjunction with the accompanying drawings, wherein:

FIG. 1 shows a flowchart illustrating a method for display and tracking of legal activity according to at least one embodiment of the present disclosure.

FIG. 2 shows a user interface for a system for display and tracking of legal activity according to at least one embodiment of the present disclosure.

FIG. 3 shows a user interface for a system for display and tracking of legal activity according to at least one embodiment of the present disclosure.

FIG. 4 shows a user interface for a system for display and tracking of legal activity according to at least one embodiment of the present disclosure.

FIG. 5 shows a block diagram of at least one embodiment of a system for display and tracking of legal activity according to the present disclosure.

### DESCRIPTION

In the present disclosure, various embodiments of systems, methods, and computer-readable programs for display and tracking of legal activity are disclosed. The systems, methods, and computer-readable programs disclosed herein enable an entity, entities, individual, or individuals (e.g., enterprises, legal teams, audit teams, collection departments and others) to track legal activities performed in various cases within various court systems and to identify procedural patterns for each tracked case. In addition, the systems, methods, and computer-readable programs disclosed herein facilitate the display of procedural information important to each court case in an efficient way to enable an enterprise to quickly identify what has been performed in each case, what needs to happen next, sample forms that can used to initiate the next step, and the actual and predicted costs associated therewith.

The systems, methods, and computer-readable programs described in the present disclosure enable the tracking and display of procedural information and legal activities performed in court cases throughout multiple jurisdictions. As used in the present disclosure, a legal activity includes, but is not limited to, any filing or procedural activity within a court case, such as, for example, a complaint, service of process, discovery, answer, and motions. It should be appreciated that the systems, methods, and computer-readable programs disclosed herein may be used to track and display court activity in any case in any legal jurisdiction, including, but not limited to, administrative courts, United States district courts, State courts, alternative dispute resolution proceedings with procedural rule sets, and foreign courts.

While this disclosure has been described as having various embodiments, these embodiments according to the present disclosure can be further modified within the scope and spirit of this disclosure. This application is therefore intended to cover any variations, uses, or adaptations of the disclosure using its general principles. For example, any methods disclosed herein represent one possible sequence of performing the steps thereof. A practitioner may determine in a particular implementation that a plurality of steps of one or more of the disclosed methods may be combinable, or that a different sequence of steps may be employed to accomplish the same results. Each such implementation falls within the scope of the present disclosure as disclosed herein and in the appended claims. Furthermore, this application is intended to cover such departures from the present disclosure as come within known or customary practice in the art to which this disclosure pertains.

Referring now to FIG. 1, there is shown a flowchart of a method 100 for display and tracking of legal activity according to at least one embodiment of the present disclosure. As shown in FIG. 1, the method 100 includes establishing a court that a legal proceeding is initiated in in step 101, generating a suggested procedural sequence for such court in step 102, and tracking performed legal activities in such legal proceeding in step 103. It should be appreciated that it is within the scope of the present disclosure to perform only some of the steps in the method 100 and that the steps displayed in the method 100 need not be performed the sequence shown in FIG. 1.

In at least one embodiment of the present disclosure, the method 100 includes establishing, in a system according to an embodiment of the present disclosure, a legal proceeding that is pending or may be pending in the future, in step 101. In such an embodiment, establishing a legal proceeding includes identifying, in a system according to an embodiment of the present disclosure, the jurisdiction and court where the legal proceeding is or may be pending. In at least one embodiment of the present disclosure, establishing a court can also include identifying, in a system according to an embodiment of the present disclosure, information regarding a particular legal proceeding that is pending or may be pending in the future, such as, for example, the plaintiff, defendant, judge, and/or cause of action. As used in the present disclosure, a legal proceeding may include, but is not limited to, a civil, criminal, administrative, or other case within a court in any jurisdiction. For example, a legal proceeding may include a civil case involving a complaint that alleges infringement of a United States copyright against a defendant filed in a United States District Court. In another example, a legal proceeding may include a State court case for the collection of unpaid debt.

In at least one embodiment of the present disclosure, the method 100 includes generating a suggested procedural sequence in step 102. In such an embodiment, generating a suggested procedural sequence includes identifying a list of legal activities to be performed in a legal proceeding (e.g., filing the complaint, service of the complaint, answering the complaint, etc.). While a standard procedural sequence will be made available, in at least one embodiment the present disclosure accounts for the fact that a standard procedural sequence may differ by virtue of the differences of procedure in different courts.

Accordingly, in at least one embodiment of the present disclosure, as the user initiates a legal proceeding in a court for the first time, the system can keep track of the procedural sequence, and requirements for such court and a procedural sequence is created through a pattern established from the information generated through conducting the legal proceeding in that court. In this manner, when the user initiates a legal proceeding in that court a second time, the same procedural sequence will be used assisting the user in knowing what steps need to occur in initiating and litigating a complaint in such court. In such an embodiment, the suggested procedural sequence will include baseline suggestions for filings of any legal activity in any court. In at least one embodiment of the present disclosure, the baseline suggestions may be broken up between phases in a legal proceeding, such as, for example pre-judgment and post-judgment.

In at least one embodiment of the present disclosure, as legal activities are performed in various legal proceedings, information, documents, and costs are associated with each type of legal activity and type of legal proceeding. In such an embodiment, the performance of the legal activities creates a pattern of behavior to be used as a baseline to generate the suggested procedural sequence in similar legal proceedings in step 102. It should be appreciated that the suggested procedural sequence provides benefits in management of legal activities, especially as it relates to collection actions being initiated and managed by collection agencies, to avoid filing errors, unnecessary expense, and missed opportunities to perform legal activities.

In at least one embodiment of the present disclosure, the suggested procedural sequence includes document templates for each legal activity that is part of the procedural sequence. In such an embodiment, a suggested legal activity may include one or more document templates that may be used to efficiently create the necessary paperwork for filing purposes. For example, in the event that a suggested legal activity in the procedural sequence is that a party files suit against an individual, a suggested template for a complaint may be included that is related to the legal proceeding. In this example, if the legal proceeding is directed to the collection of unpaid debt from a debtor, the document template for the file suit legal activity may include a prepopulated complaint to state a cause of action for the collection of unpaid debt against the debtor. It should be appreciated that the document templates for each legal activity may vary between jurisdiction and type of legal proceeding. For example, a template for a complaint in the United States District Court for the Southern District of Indiana for the collection of unpaid debt may vary from a template for a complaint in the Circuit Court of Cook County, Illinois for the collection of unpaid debt.

In at least one embodiment of the present disclosure, the suggested procedural sequence includes costs and/or wait times for each legal activity. In such an embodiment, a suggested legal activity will include previously identified costs associated with the legal activity and/or the court in which such legal activity is taken, such as, for example filing costs. In such an embodiment, the previously identified costs will be populated based on other legal proceedings that have already performed the legal activity and associated costs with the legal activity for future use. In such an embodiment, wait times may be included for each legal activity that identify the expected time to wait between performing a legal activity and receiving a status from the court in which the legal activity was performed.

In at least one embodiment of the present disclosure, single deviations from established patterns of legal activities will not alter the suggested procedural sequence for a specific court. In such an embodiment, while users are able to deviate from the suggested procedural sequence, the present disclosure will initially treat such deviations as anomalies and will not change the suggested procedural sequence unless it detects a pattern that such deviation is becoming routine for the particular court. For example, in at least one embodiment of the present disclosure if the automatically suggested procedural sequence for a particular court and/or a particular cause of action is deviated from in the same way five consecutive times, the deviation automatically is adopted into the suggested procedural sequence, and a revised procedural sequence becomes the new automatically suggested procedural sequence. It should be appreciated that patterns are established by court and legal action and suggested legal activities within a pattern may include costs, time to wait in between activities, and templates of documents to be used in any legal activities. In an exemplary embodiment, a procedural pattern is established based on the process executed in a majority of legal proceedings for such court. It should be appreciated that the suggested legal activities or any information associated therewith (cost, document templates, etc.) may be changed and that the suggested procedural sequence is merely a suggestion for ease of use and efficiency.

An example suggested procedural sequence is shown for a collection action taking place in the County Court based in Chesterfield, Va. in FIG. 2. There, the initial suggested legal activity to be performed is to “File Suit.” In this example, the suggestion to “File Suit” has been determined based on the jurisdiction identified (Chesterfield, Va. County Court) where, in this example, the court requires that a party file a suit to initiate a legal proceeding. In this example, as shown in FIG. 2, the suggested legal activity also includes a cost associated therewith. In this example, the cost associated with the suggested legal activity is generated based on previously identified costs for similar legal activities performed in this court. In this example, the next legal activity suggested in this legal proceeding would be to request service. In this example, if requesting service has been performed in the Chesterfield, Va. County Court before, the costs and documents associated with this legal activity will be suggested as well as the number of days to wait before following up to request status of the service.

In at least one embodiment of the present disclosure, the suggested procedural sequence includes individual legal activities to perform with associated documents that are specific to the type of legal proceeding, legal activity and jurisdiction. For example, as shown in FIG. 2, a legal activity associated with filing a suit in a legal proceeding for the Chesterfield, Va. County Court may include specific document templates to be used when filing the legal activity. It should be appreciated that the documents provided as templates in each legal activity may change depending on the type of legal activity to be performed, the applicable jurisdiction, the type of legal proceeding, and other factors.

In at least one embodiment of the present disclosure, the method 100 includes tracking performed legal activities in step 103. In such an embodiment, as legal activities are performed, the performance of the legal activity is stored to track the progress of the legal proceeding. In such an embodiment, information may be associated with the performance of the legal activity, such as, for example, documents filed, documents received from the court in response, costs, and/or the date of any hearing or court activity generated in association with the legal activity. It should be appreciated that the tracking of performance of legal activities in step 103 may impact established patterns for generating suggested procedural sequences as used in step 102 in future executions of the method 100.

In at least one embodiment of the present disclosure, legal activities performed in a legal proceeding are displayed to enable an enterprise to efficiently identify the legal activities performed, the legal activities suggested to be performed, a status, and other information. In at least one embodiment of the present disclosure, a legal activity that is performed in a suggested procedural sequence is updated in display to include information associated with that legal activity. For example, after filing suit, the display would update the “File Suit” legal activity with the case number assigned by the court where the suit was filed.

In at least one embodiment of the present disclosure related to collection actions, the display includes the names of parties, costs incurred, costs recovered, cost allocation between a collection agency and creditor, and/or where damages recovered are to be allocated between a collection agency and creditor in any legal proceeding. The costs incurred and recovered can be tracked for myriad reasons and uses. For example, with the collection process, the collection agency may get investment money from the creditor (its client) to pursue litigation and will attempt to recover the court costs from the debtor. Based on the investment made or if the collection agency requires the creditor to advance money for litigation prior to taking any litigation activity, the costs of the case will be kept and further funds will be requested from the creditor once a threshold is reached. At the conclusion of the case, any unused amounts provided by the creditor will be returned and any recovery will be appropriate provided to either the collection agency, the creditor or split among them based on who was responsible for the costs of the legal activity.

In at least one embodiment of the present disclosure, the display of legal activities within a legal proceeding may be filtered based on various information about the legal proceeding, such as, for example, filter by party name, legal activity type, costs, and other information. An example of a display of a legal proceeding according to at least one embodiment of the present disclosure is shown in FIGS. 3-4.

A computer-readable medium, such as a non-volatile storage medium, may comprise computer instructions for carrying out the steps of the method for tracking and displaying legal activity described above. For instance, the method may be incorporated into a computer program to track and display legal activities within a legal proceeding. The computer program may be generated in any software language or framework such as C#, COBOL, C++, Microsoft® .NET Framework, Ruby on Rails, or the like.

The computer-readable medium for performing the embodiments of the present disclosure may include computer-readable program code portions, such as a series of computer instructions, embodied in the computer-readable medium. It should be understood that the computer-readable program code portions may include separate executable portions for performing distinct functions to accomplish embodiments of the present disclosure. Additionally, or alternatively, one or more of the computer-readable program portions may include one or more executable portions for performing more than one function to thereby accomplish embodiments of the process of the present disclosure.

In conjunction with the computer-readable medium, a computer that includes a processor, such as a programmable-variety processor responsive to software instructions, a hardwired state machine, or a combination of these may be used to carryout the method disclosed above. Such computers may also include memory, which in conjunction with the processor is used to process data and store information. Such memory can include one or more types of solid state memory, magnetic memory, or optical memory, just to name a few. By way of non-limiting example, the memory can include solid state electronic random access memory (RAM); sequential access memory (SAM), such as first-in, first-out (FIFO) variety or last-in, first-out (LIFO) variety; programmable read only memory (PROM); electronically programmable read only memory (EPROM); or electronically erasable programmable read only memory (EEPROM); an optical disc memory (such as a DVD or CD-ROM); a magnetically encoded hard disc, floppy disc, tape, or cartridge media; or a combination of these memory types. In addition, the memory may be volatile, non-volatile, or a hybrid combination of volatile and non-volatile varieties. The memory may include removable memory, such as, for example, memory in the form of a non-volatile electronic memory unit; an optical memory disk (such as a DVD or CD ROM); a magnetically encoded hard disk, floppy disk, tape, or cartridge media; or a combination of these or other removable memory types.

The computers described above may also include a display upon which information may be displayed in a manner perceptible to the user, such as, for example, a computer monitor, cathode ray tube, liquid crystal display, light emitting diode display, touchpad or touchscreen display, and/or other means known in the art for emitting a visually perceptible output. Such computers may also include one or more data entry means or devices, such as, for example, a keyboard, keypad, pointing device, mouse, touchpad, touchscreen, microphone, and/or other data entry means known in the art. Each computer also may comprise an audio display means such as one or more loudspeakers and/or other means known in the art for emitting an audibly perceptible output.

One or more such computers may be configured to be a server. Such a server need not, however, be a single server. A server according to the present disclosure may comprise a plurality of servers or other computing devices or systems connected by hardware and software that collectively are operable to perform the computing functions according to the present disclosure. In at least one embodiment, such a server may be operable to be a web server, configured and programmed to carry out the computing functions according to the present disclosure.

In at least one embodiment of the present disclosure, a database resides on such a server and stores information and data utilized in the course of the present disclosure. For example, information about legal proceedings that are pending or may be pending in the future is stored in the database; information about the jurisdiction and court where a legal proceeding is or may be pending is stored in the database; information necessary for generating a suggested procedural sequence is stored in the database; information about baseline suggestions for filings of any legal activity in any court is stored in the database; information about documents and costs are associated with each type of legal activity and type of legal proceeding is stored in the database; information about document templates for each legal activity is stored in the database; and information about costs and/or wait times for each legal activity is stored in the database. In at least one embodiment of the present disclosure, such a database resides on a computing device remote from the server, provided the remote computing device is capable of bi-directional electronic communication with the server. Preferably, the remote computing device upon which the database resides may be electronically connected to the server such that the remote computing device is in continuous bi-directional communication with the server. It will be appreciated that such database may comprise a plurality of databases connected by software that collectively are operable to perform the functions according to the present disclosure.

FIG. 5 shows a block diagram of at least one embodiment of a system for display and tracking of legal activity according to the present disclosure. Shown in FIG. 5 is server 501, on which database 502 is stored. Server 501 comprises one or more host servers, computing devices, or computing systems configured and programmed to carry out the functions allocated to server 501 according to the present disclosure. Server 501 comprises at least one processor and at least one form of memory, including but not limited to a recordable computer-readable medium. Server 501 may be operated by, or under the control of, a “system operator,” which may be an individual or a business entity. For purposes of clarity, server 501 is shown in FIG. 5 and referred to herein as a single server. Server 501 need not, however, be a single server. Server 501 may comprise a plurality of servers or other computing devices or systems connected by hardware and software that collectively are operable to perform the functions allocated to server 501 according to the present disclosure. In at least one embodiment, server 501 may be operable to be a web server, configured and programmed to carry out the functions allocated to server 501 according to the present disclosure.

In the embodiment shown in FIG. 5, database 502 resides on server 501. Database 502 may, however, reside on a server or computing device remote from server 501, provided the remote server or computing device is capable of bi-directional electronic communication with server 501. The remote server or computing device upon which database 502 resides may be operated by, or under the control of, the system operator. Preferably, the remote server or computing device upon which database 502 resides may be electronically connected to server 501 such that the remote server or computing device is in continuous bi-directional communication with server 501. For purposes of clarity, database 502 is shown in FIG. 5 and referred to herein as a single database. It will be appreciated that database 502 may comprise a plurality of databases connected by software that collectively are operable to perform the functions allocated to database 502 according to the present disclosure.

In at least one embodiment of the present disclosure, server 501 comprises at least two computing devices in a redundant configuration. In such an embodiment, in the case of a failure of one such computing device or a failure of the connection between one such computing device and network 504, the other such computing device will automatically become available to carry out the functions allocated to server 501 according to the present disclosure. In such an embodiment, database 502 is replicated on at least two such computing devices. In at least one such embodiment, at least two such computing device are electronically interconnected by dual path, redundant electronic interconnection.

Also shown in FIG. 5 are computer network 504 and computing devices 505. For purposes of clarity, computer network 504 is shown in FIG. 5 as a single computer network. Computer network 504 may, however, comprise a plurality of computer networks. Computer network 504 may comprise a global computer network, such as, for example, the Internet. Computing devices 505 are computers, computing devices, or computing systems, such as one or more mainframe computers, workstations, personal computers, laptop computers, hand-held computers, smart phones, tablets, cellular phones, or other Internet-enabled devices. Computing devices 505 each comprises at least one processor and at least one form of memory, including but not limited to a recordable computer-readable medium. If computer network 504 comprises the Internet, resident on computing devices 505 is a software for browsing the Internet and interpreting and displaying webpages, such as, for example, Internet Explorer® or Mozilla® or Safari® or Chrome™. Computing devices 505 are operated by users of a system for display and tracking of legal activity according to the present disclosure.

While the description above refers to particular embodiments of the present invention, it will be understood that many modifications may be made without departing from the spirit thereof. The presently disclosed embodiments are therefore to be considered in all respects illustrative and not restrictive, the scope of the invention being indicated by the appended claims, rather than the foregoing description, and all changes which come within the meaning and range of equivalency of the claims are therefore intended to be embraced therein.

What is claimed is:

1. A method for tracking and displaying legal activity, the method comprising the steps of:
establishing legal proceeding information in a computer database, the legal proceeding information including a type and a jurisdiction;
generating, with the assistance of a computer, a suggested procedural sequence based at least in part on the type and the jurisdiction; and
tracking, with the assistance of a computer, at least one legal activity.

2. A method of claim 1, further comprising the step of:
suggesting form documents to be used to initiate the at least one legal activity.

3. A method of claim 1, further comprising the step of:
providing the costs associated with the at least one legal activity.

4. A method of claim 1, further comprising the step of:
providing reminders related to estimated time period for response actions to occur in view of the at least one legal activity.

5. A system for tracking and displaying legal activity, the system comprising:
a non-transitory computer-readable medium with a computer program for tracking and displaying legal activity stored thereon, the non-transitory computer-readable medium comprising code portions stored thereon, the computer-readable medium code portions comprising:
a first executable code portion for identifying a court for a legal proceeding,
a second executable code portion for generating a suggested procedural sequence based at least in part on the identified court, and
a third executable code portion for tracking at least one legal activity performed in the legal proceeding; and
and a processor for executing the code portions.

6. A system of claim 6, wherein the system further comprises a fourth executable code portion for suggesting form documents to be used to initiate the at least one legal activity.

7. A system of claim 6, wherein the system further comprises a fourth executable code portion for providing the costs associated with the at least one legal activity.

8. A system of claim 6, wherein the system further comprises a fourth executable code portion for providing a reminder related to an estimated time period for response actions to occur in view of the at least one legal activity.

9. A non-transitory computer-readable medium with a computer program for tracking and displaying legal activity stored thereon, the non-transitory computer-readable medium comprising code portions stored thereon, the computer-readable medium code portions comprising:
a first executable code portion for identifying a court for a legal proceeding;
a second executable code portion for generating a suggested procedural sequence based at least in part on the identified court; and
a third executable code portion for tracking at least one legal activity performed in the legal proceeding.
